(19) United States
(12) Patent Application Publication
(10) Pub. No.: US 2009/0294493 A1
(43) Pub. Date: Dec. 3, 2009

(54) GARMENT HANGER INCLUDING SLIDE-IN SIZER

(75) Inventors: Leung Ho, Kowloon (HK); Kevin R. Sullivan, Annandale, NJ (US)

Correspondence Address: HOFFMANN & BARON, LLP, 6900 JERICHO TURNPIKE, SYOSSET, NY, 11791, US

(73) Assignee: THE BUILD-UP PLASTIC & METAL CO., LTD., Kowloon (HK)

(21) Appl. No.: 12/474,502

(22) Filed: May 29, 2009

Related U.S. Application Data
(60) Provisional application No. 61/118,801, filed on Dec. 1, 2008.
(60) Provisional application No. 61/057,084, filed on May 29, 2008.

(51) Int. Cl. A41D 27/22; G09F 3/20

(52) U.S. Cl. 223/85; 40/322

(57) ABSTRACT

A garment hanger having a slide-in sizer. The hanger includes a sizer-receiving frame defining at least one sizer-receiving slot for sliding receipt of a substantially flat and planar sizer. In one preferred embodiment, the sizer is formed from paper. The sizer-receiving frame may be positioned within a notch defined between the junction of the body and the base portion of the hook. Alternatively, the sizer-receiving frame may be positioned at the upper portion of the hook.

This application claims the benefit of U.S. Provisional Application Ser. No. 61/118,801 filed Dec. 1, 2008 and U.S. Provisional Application Ser. No. 61/057,084 filed May 29, 2008, the disclosures of which are hereby incorporated by reference in their entirety.

### BACKGROUND OF THE INVENTION

The present invention relates to garment hangers and, more particularly, to garment hangers having sizers coupled thereto. Garment hangers are often provided with size indicators, also known as sizers, for providing indicia relating to the size or type of garment hung on the hanger, or other information. Such indicators are often in the form of small U-shaped tabs that are clipped on the hanger body. A common location for securing a size indicator to a hanger is a web portion of the hanger formed between the bottom end of the hanger hook and the top of the hanger body. Typical prior art arrangements are disclosed in U.S. Pat. Nos. 4,115,940, 5,096,101, 5,199,608, 5,238,159, 5,305,933, 5,383,583, 5,407,109, 5,441,182 and 5,449,099.

As will be recognized by those skilled in the art, the mentioned U-shaped size indicators are typically formed of plastic, and are designed to be secured to a hanger in a substantially non-removable manner, thereby reducing the likelihood that such indicators may be inadvertently removed from the hanger. The desire to couple the size indicator to the hanger in a non-removable manner typically increases the cost and complexity of such prior art indicators. Moreover, these prior art indicators are often times clipped to the hanger in a manner which allows the indicator to “wobble,” which can detract from the overall aesthetic appeal of the hanger. It will be further appreciated that the very same design which increases the difficulty of removing the indicator from the hanger also increases the installation force required to install the indicator on the hanger body thereby rendering assembly more difficult and costly. Finally, it will be appreciated that any reduction in the usage of plastic is viewed as having a positive impact on the environment.

There is therefore a need in the art for a hanger/sizer combination which provides a less complex and costly design, which allows for ready assembly of the components, which reduces the environmental impact through decreased usage of plastic, which is more child friendly, and which provides increased flexibility for printing of indicia/graphics on the sizer.

### SUMMARY OF THE INVENTION

The present invention, which addresses the needs of the prior art, relates to a garment hanger having a slide-in side sizer. In particular, the garment hanger includes a body. The garment hanger further includes a hook having a base portion joined to the body and an outer surface forming an acute angle with the body. The acute angle defines a notch at the junction of the body and the base portion of the hook. The garment hanger further includes a sizer-receiving frame positioned within the notch. At least a portion of the frame extends between and connects the hanger body and the base portion of the hook. The frame defines a sizer-receiving slot. The hanger body and the hook and the frame are generally coplanar. Finally, the garment hanger includes a substantially flat and planar sizer positioned within the slot of the frame.

The present invention further relates to a garment hanger having a slide-in top sizer. In particular, the garment hanger includes a body and a hook extending from the body. The garment hanger further includes a sizer-receiving frame secured to an upper portion of the hook. The frame defines a sizer-receiving slot. Finally, the garment hanger includes a substantially flat and planar sizer positioned within the slot of the frame.

As a result, the present invention provides a hanger-sizer combination which is less complex and less costly in design, which allows for ready assembly of the components, which reduces the environmental impact through decreased usage of plastic, which is more child friendly, and which provides increased flexibility for printing of indicia/graphics on the sizer.

### BRIEF DESCRIPTION OF THE DRAWINGS

FIG. 1 is an elevation view showing the hanger/sizer combination of the present invention;

FIG. 2 is a view similar to FIG. 1 showing the sizer removed from the hanger;

FIG. 3 is a perspective view of the hanger/sizer combination of FIG. 1;

FIG. 4 is a view taken along lines 4-4 of FIG. 2;

FIG. 5 is an elevation view of a second embodiment of a hanger/sizer combination formed in accordance with the present invention;

FIG. 6 is a view similar to FIG. 5 showing the sizer removed from the hanger;

FIG. 7 is a perspective view of the second embodiment showing the sizer removed from the hanger;

FIG. 8 is a view taken along lines 8-8 of FIG. 7;

FIG. 9 is an exploded front perspective view of a third embodiment of a hanger and sizer formed in accordance with the present invention;

FIG. 10 is a view similar to FIG. 9 showing the hanger/sizer combination;

FIG. 11 is a view taken along lines 11-11 of FIG. 9; and

FIG. 12 is an exploded front elevational view of a fourth embodiment of a hanger and sizer formed in accordance with the present invention.

### DETAILED DESCRIPTION OF THE INVENTION

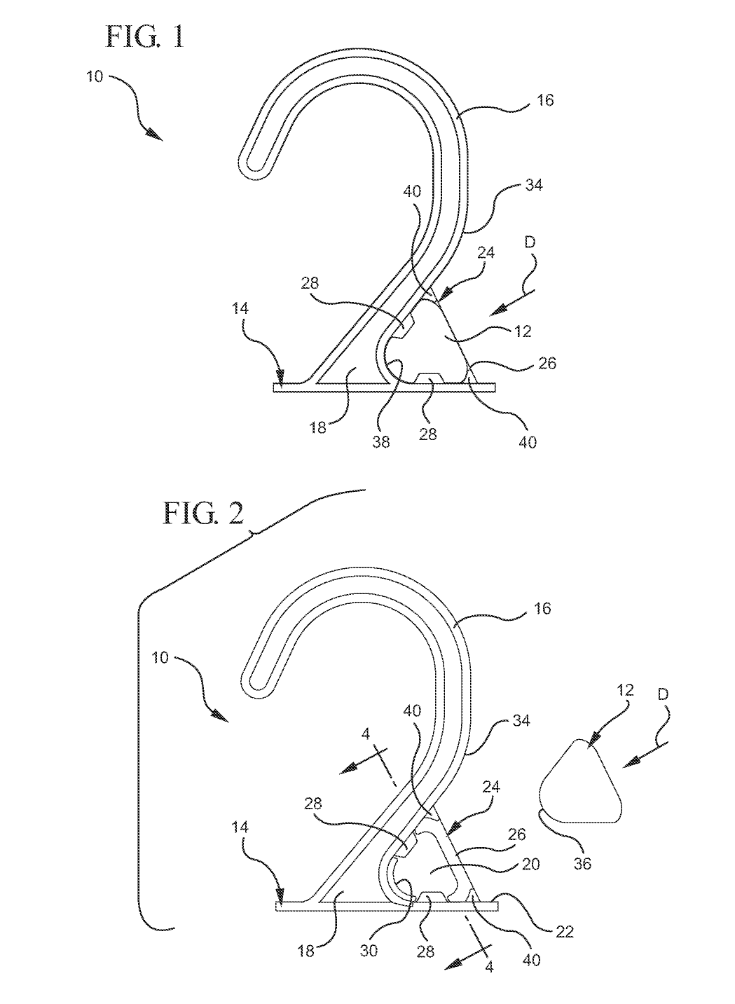

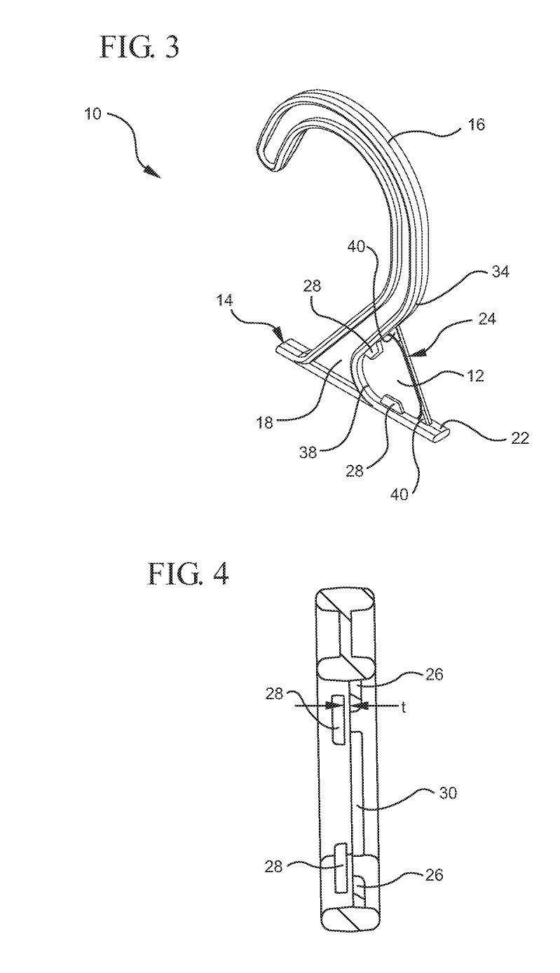

A garment hanger 10 is provided with a side sizer 12 in a manner that allows a person to easily view the information, such as garment size, provided on the sizer. As shown in FIGS. 1-3, garment hanger 10 includes a body 14. It is contemplated herein that body 14 can be formed with a pair of downwardly-depending arms as shown in U.S. Pat. No. 5,096,101 or, alternatively, can include a horizontally-extending bar as shown in U.S. Pat. Nos. 5,199,608 and 5,383,583.

A hook 16 is joined to body 14, preferably at the central portion of the hanger. The hook includes a base portion 18 that includes an outer surface extending at an acute angle with respect to an outer surface of body 14. A notch 20 is accordingly formed between base portion 18 of hook 16 and a top surface 22 of body 14.

A sizer-receiving frame 24 is positioned within notch 20. The frame is integral with both body 14 and base portion 18 of hook 16. Frame 24 includes a sizer-supporting arm 26, a pair of sizer-supporting tabs 28, and a sizer-supporting edge 30 located at the apex of notch 20. As best seen in FIG. 4, arm 26 and tabs 28 together define a sizer-receiving slot 32 having a thickness t approximately equal to the thickness of sizer 12.

Thus, garment hanger 10 (except for sizer 12) is preferably an integrally molded plastic structure. It includes a substantially continuous peripheral wall 34 that provides stiffness. The wall may include gaps (not shown) in certain portions of the hanger that may be used to support garments or may be provided with clips or the like (not shown).

Sizer 12 is preferably an integrally formed component. In one preferred embodiment, sizer 12 is formed of paper, thus reducing the overall usage of resin in the hanger/sizer combination. As will be appreciated by those skilled in the art, this reduction in usage of resin is believed to be positive for the environment. Moreover, the usage of paper for the sizer provides a more child-friendly product, as well as an improved base for printing and/or application of graphics thereon. Although paper is the preferred material for sizer 12, it is nonetheless completed herein that sizer 12 could be formed of plastic or other suitable material.

As shown, sizer 12 is a substantially flat planar member, and is shaped and sized to substantially match the configuration of notch 20. More particularly, sizer 12 is shaped and sized to rest against the top surface of arm 26 (as viewed in FIG. 2), to rest against the bottom surfaces of tabs 28 (as viewed in FIG. 2), and to rest against the top surface of edge 30 (as viewed in FIG. 2). To assemble the hanger/sizer combination, sizer 12 is inserted into slot 32 of frame 24 in the direction of arrows D. In one preferred embodiment, sizer 12 is inserted until nose portion 36 contacts surface 38 of notch 20. It will be appreciated that installation of the present sizer requires significantly less installation force than prior art U-shaped plastic sizers, thereby making the assembly process easier and less costly. It also allows the sizer to be more easily removed from the hanger, if desired (e.g., during recycling).

In another preferred embodiment, arm 26 is provided with a pair of locking corners 40 on the top surface thereof (as viewed in FIG. 2). The corners are preferably sized and shaped so as to allow sizer 12 to be readily inserted therepast, but which resist movement of the sizer in a withdrawal direction. Thus, corners 40 act to secure the sizer within the frame once such sizer is fully inserted. In another preferred embodiment, an adhesive can be located on one or both of the sizer and arm 26 to assist in securing the sizer within frame 24.

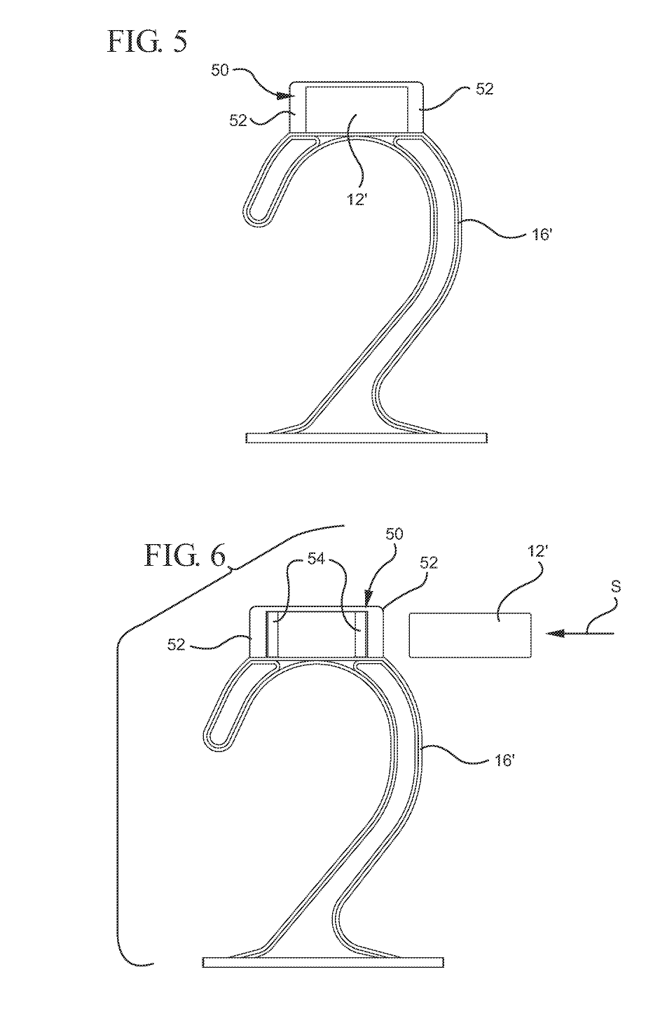

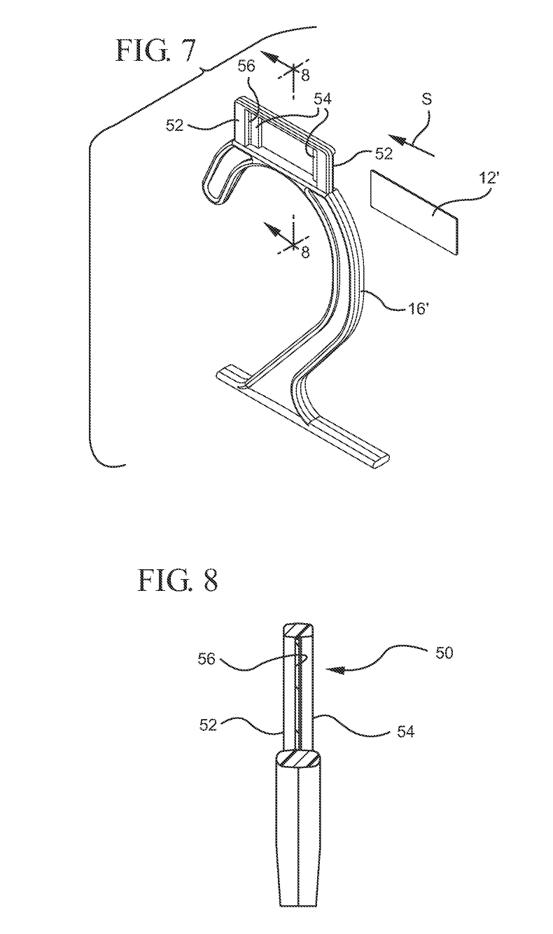

Although the embodiment shown in FIGS. 1-4 is directed to what is commonly referred to as a side sizer, it is contemplated herein that the slide-in sizer of the present invention can also be used in a top sizer arrangement. More particularly, as shown in FIGS. 5-8, a sizer-receiving frame 50 can be secured to an upper portion of hook 16′ and can be sized and shaped to receive an alternative sizer, e.g., top sizer 12′. In this regard, frame 50 preferably includes opposing edges 52, and a pair of sizer-supporting walls 54. A sizer-receiving slot 56 is defined between edges 52 and walls 54, and is sized to receive sizer 12′. In particular, sizer 12′ is inserted into slot 56 of frame 50 in the direction of arrows S until the sizer is fully received therein. Once inserted, the sizer preferably rests against the surfaces defined by edges 52 and walls 54.

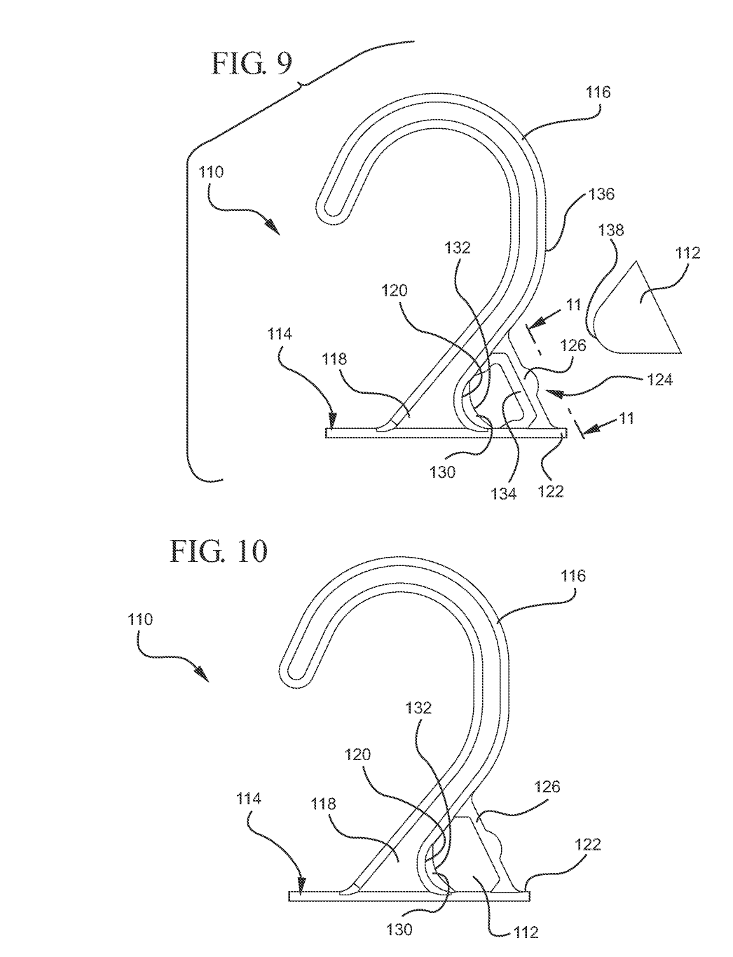

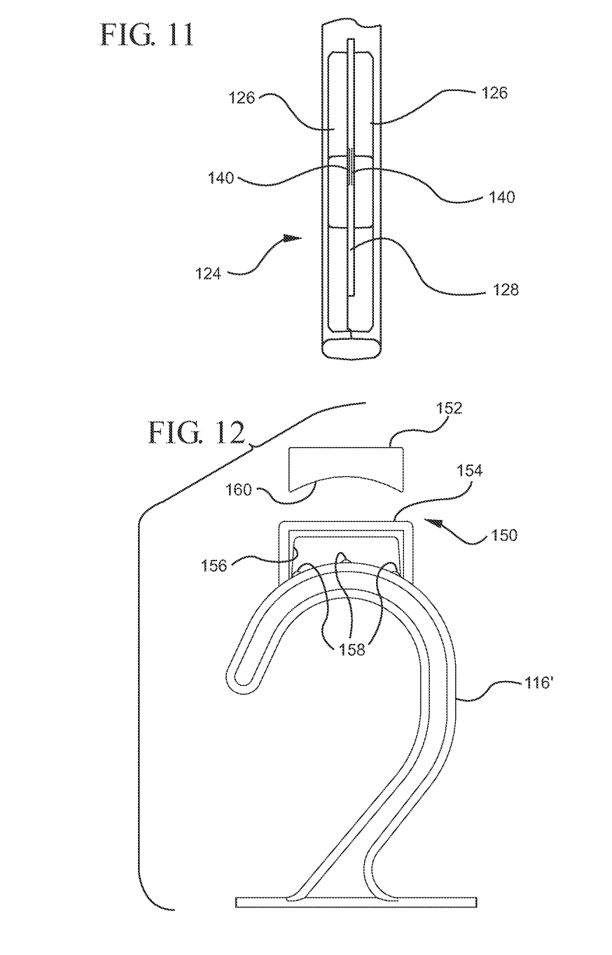

In another embodiment of the present invention, a garment hanger 110 is provided with a side sizer 112 in a manner that allows a person to easily view the information, such as garment size, provided on the sizer. As shown in FIGS. 9-11, garment hanger 110 includes a body 114. It is contemplated herein that body 114 can be formed with a pair of downwardly-depending arms as shown in U.S. Pat. No. 5,096,101 or, alternatively, can include a horizontally-extending bar as shown in U.S. Pat. Nos. 5,199,608 and 5,383,583.

A hook 116 is joined to body 114, preferably at the central portion of the hanger. The hook includes a base portion 118 that includes an outer surface extending at an acute angle with respect to an outer surface of body 114. A notch 120 is accordingly formed between base portion 118 of hook 116 and a top surface 122 of body 114.

A sizer-receiving frame 124 is positioned within the notch. The frame is integral with both body 114 and base portion 118 of hook 116. Frame 124 includes opposing walls 126 defining a slot 128 therebetween, as well as opposing walls 130 defining a second slot 132 therebetween. Frame 124 may further include a pair of opposing sizer-supporting edges 134 extending at least partially between walls 126 and walls 130.

Thus, garment hanger 110 (except for sizer 112) is preferably an integrally molded plastic structure. It includes a substantially continuous peripheral wall 136 that provides stiffness. The wall may include gaps (not shown) in certain portions of the hanger that may be used to support garments or may be provided with clips or the like (not shown).

Sizer 112 is preferably an integrally formed component. In one preferred embodiment, sizer 112 is formed of paper, thus reducing the overall usage of resin in the hanger/sizer combination. As will be appreciated by those skilled in the art, this reduction in usage of resin is believed to be positive for the environment. Moreover, the usage of paper for the sizer provides a more child-friendly product, as well as an improved base for printing and/or application of graphics thereon. Although paper is the preferred material for sizer 112, it is nonetheless completed herein that sizer 112 could be formed of plastic or other suitable material.

As best seen in FIG. 10, sizer 112 is shaped and sized to substantially match the configuration of notch 120. To assemble the hanger/sizer combination, sizer 112 is inserted through slot 128 and into notch 120 until apex 138 of sizer 112 is received within slot 132 defined by opposing walls 130. In this position, sizer 112 is supported by opposing walls 126, opposing walls 130 and by edges 134.

In one preferred embodiment, opposing walls 126 are provided with a pair of ramping surfaces 140 which allows sizer 112 to be readily inserted therepast, but which resist movement of the sizer in a withdrawal direction. In another preferred embodiment, an adhesive can be located on one or both of the sizer and frame to assist in securing the sizer to the frame. In still another preferred embodiment, the sizer-receiving frame can include opposing edges 134 to provide additional support to the sizer around the periphery thereof.

In still another preferred embodiment, as shown in FIG. 12, a sizer-receiving frame 150 can be secured to an upper portion of hook 116 and can be sized and shaped to receive an alternative sizer, e.g., top sizer 152. In this regard, frame 150 preferably includes a pair of opposing walls 154 defining a slot therebetween, as well as a supporting edge 156. Finally, the frame preferably includes plurality of opposing ribs 158 which define a slot for receiving and supporting the leading insertion edge 160 of sizer 152. Of course, it is contemplated herein that the sizer-receiving frame can be designed in various shapes, and can also be designed to allow the sizer to be inserted from a side edge thereof.

Thus, while there have been described what are presently believed to be the preferred embodiments of the present invention, those skilled in the art will appreciate other and further changes and modifications thereto, and it is intended to include such other changes as come with the scope of the invention.

1. A garment hanger, comprising:
a body;
a hook having a base portion joined to said body and an outer surface forming an acute angle with said body, said acute angle defining a notch at the junction of said body and said base portion of said hook;
a sizer-receiving frame positioned within said notch, at least a portion of said frame extending between and connecting said hanger body and said base portion of said hook, said frame defining a sizer-receiving slot, said hanger body and said hook and said frame being generally coplanar;
a substantially flat and planar sizer positioned within said slot of said frame.

2. The garment hanger according to claim 1, wherein said sizer-receiving frame includes a sizer-supporting arm, a pair of opposing sizer-supporting tabs, and a sizer-supporting edge, wherein said edge is located at the apex of said notch.

3. The garment hanger according to claim 2, wherein said arm and said edge extend through a first plane, and wherein said tabs extend through a second plane, said first plane being coplanar to said second plane, and wherein said sizer-receiving slot is defined by said planes.

4. The garment hanger according to claim 3, further comprising a pair of opposing locking corners located on and extending from said arm for retaining said sizer within said slot.

5. The garment hanger according to claim 4, wherein said sizer is formed of paper.

6. The garment hanger according to claim 1, wherein said sizer-receiving frame includes first and second sets of opposing walls, and wherein said opposing walls define said sizer-receiving slot therebetween.

7. The garment hanger according to claim 6, wherein one of said sets of opposing walls includes at least one ramping surface to allow insertion of said sizer therepast while resisting withdrawal of said sizer from said frame.

8. The garment hanger according to claim 7, wherein said sizer is formed of paper.

9. A garment hanger, comprising:
a body;
a hook extending from said body;
a sizer-receiving frame secured to an upper portion of said hook, said frame defining a sizer-receiving slot; and
a substantially flat and planar sizer positioned within said slot of said frame.

10. The garment hanger according to claim 9, wherein said sizer-receiving frame includes a pair of opposing edges and a pair of opposing sizer-supporting walls, said edges defining a first plane and said walls defining a second plane, and wherein said slot is located between said first and second planes.

11. The garment hanger according to claim 10, wherein said frame has a substantially rectangular shape, and wherein said sizer has a substantially corresponding rectangular shape.

12. The garment hanger according to claim 11, wherein said sizer is formed of paper.

13. The garment hanger according to claim 9, wherein said sizer-receiving frame includes a pair of opposing walls and at least one pair of opposing ribs, said slot being defined between said walls and said ribs.

14. The garment hanger according to claim 13, wherein the leading insertion edge of said sizer has a concave configuration.

15. The garment hanger according to claim 14, wherein said sizer is formed of paper.
